(19) United States
(12) Patent Application Publication
(10) Pub. No.: US 2010/0220063 A1
(43) Pub. Date: Sep. 2, 2010

(54) SYSTEM AND METHODS FOR CALIBRATABLE TRANSLATION OF POSITION

(75) Inventor: Yue Fei, San Jose, CA (US)

Correspondence Address: HARNESS, DICKEY & PIERCE, P.L.C., P.O. BOX 828, BLOOMFIELD HILLS, MI, 48303, US

(73) Assignee: PANASONIC CORPORATION, Osaka (JP)

(21) Appl. No.: 12/394,304

(22) Filed: Feb. 27, 2009

(51) Int. Cl. G06F 3/041

(52) U.S. Cl. 345/173

(57) ABSTRACT

A calibratable system for translating a position input by a user to a first device to a position output of a second device includes a translation module and a calibration module. The translation module receives the position input by the user to the first device and that translates the position input to position output for the second device based on a plurality of parameters and a translation method. The calibration module selectively generates the plurality of parameters based on a calibration method that commands the user to move the position input to locations defined by the calibration method.

### FIELD

The present disclosure relates to translation of position input between two devices, and more particularly to a calibratable translation system for position input by an appendage that is limited by a corresponding joint of a user.

### BACKGROUND

For a graphical user interactive system that includes a pointing device (e.g. a mouse, a touchpad, a touch screen, etc.) and a display device (e.g. a projector screen), positional input from the pointing device is translated to an output position on the display device. For example, the translation may be a linear translation. In other words, the movement of the pointing device is proportional to the movement of position on screen. Thus, if a user moves an appendage in a straight line with respect to the pointing device, the cursor moves in a straight line on the display device. However, there are several problems associated with linear translations.

First of all, due to physical movement limitations of certain appendages of the human body, it may be difficult or impossible to move in certain directions. For example, a thumb may be easier to move along or perpendicular to the line of a fingertip due to the carpometacarpal joint. Conversely, for example, it may be difficult, painful, or impossible to move the thumb in straight lines (i.e. vertical and horizontal). However, most applications require straight horizontal or vertical movements on the screen, either because of the layout of the graphical user interface, or because of the nature of the task (e.g. drawing a straight line in drawing software). When a user is required to move his thumb in a physical straight line, especially horizontal or vertical straight lines, the user may need precise cooperation of several muscles groups and constant visual feedback to adjust the muscles. Furthermore, even with the additional effort, resulting movement on the display device may be poor.

Alternatively, due to psychological reasons, the user may expect movement different than the actual physical movement. For example, when the thumb is moving perpendicular to the line of a fingertip (i.e. rotating about the carpometacarpal joint), the user may think he is moving the thumb horizontally, even though the actual physical movement is an arc. Therefore, using a linear translation, the user may move the pointer to an unintended position. This inaccurate control may require the user to frequently monitor the pointer position displayed on the screen and correct his thumb movement. This may be difficult, painful, and may result in more errors.

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

### SUMMARY

This section provides a general summary of the disclosure, and is not a comprehensive disclosure of its full scope or all of its features.

A method for translating a position input by a user to a first device to a position output of a second device includes defining an area of the first device in which input by the user is expected, where the area is less than a total area of the first device, and where the area has a boundary with at least one non-linear side, receiving position input in the defined area of the first device, and translating the position input by the user to the first device to the position output of the second device based on a translation method.

A method for translating a position input from an appendage of a user on a touchpad to a position on a display having a rectangular shape includes defining an area on the touchpad in which input movement by the appendage of the user is expected based upon the natural movement of joints associated with the appendage, receiving the position input in the area on the touchpad, and translating the position input in the area on the touchpad to the position on the display using a translation method.

A calibratable system for translating a position input by a user to a first device to a position output of a second device includes a translation module and a calibration module. The translation module receives the position input by the user to the first device and that translates the position input to position output for the second device based on a plurality of parameters and a translation method. The calibration module that selectively generates the plurality of parameters based on a calibration method that commands the user to move the position input to locations defined by the calibration method.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1B illustrate non-linear movement of a thumb relative to a standard coordinate system according to the present disclosure;

FIG. 2 is a functional block diagram of a system that includes a calibratable translation system according to the present disclosure;

FIGS. 3A-3C are graphical representations of a first exemplary translation method according to the present disclosure;

FIG. 4 is a flow diagram of the first exemplary translation method according to the present disclosure;

FIGS. 5A-5C is a graphical representation of a second exemplary translation method according to the present disclosure;

FIG. 6 is a flow diagram of the second exemplary translation method according to the present disclosure;

FIGS. 7A-7B are graphical representations of a first exemplary calibration method according to the present disclosure;

FIG. 8 is a flow diagram of the first exemplary calibration method according to the present disclosure;

FIGS. 9A-9C are graphical representations of a second exemplary calibration method according to the present disclosure;

FIG. 10 is a flow diagram of the second exemplary calibration method according to the present disclosure; and

FIGS. 11A-11E illustrate various embodiments of the calibratable translation system according to the present disclosure.

Corresponding reference numerals indicate corresponding parts throughout the several views of the drawings.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

A system and methods are presented for calibratable translation of a position input to an input device (e.g. a touchpad) to an output position of an output device (e.g. a display). The translation allows the user to move an appendage (e.g. a thumb) in a trajectory that the user mentally intends to move on the output device. Thus, the user may reach the full space of the output device without having to move the appendage into difficult or painful regions. Therefore, the user may easily move to a target point the user mentally intended to reach on the output device without heavy mental involvement.

Additionally, the calibration allows the user to calibrate the translation based on parameters associated with the user, such as range of movement and size of the appendage. Thus, translation of position input for the calibrated user may be more precise (i.e. improved performance). Alternatively, the calibration allows multiple users to calibrate the translation based on parameters associated with each of them. Thus, each user may access his own calibrated translation. Additionally, a group calibration may be generated by averaging the parameters corresponding to all (or a sub-set of) the users. Thus, the group calibrated translation may be implemented for a group of users (e.g. a family living in a same household).

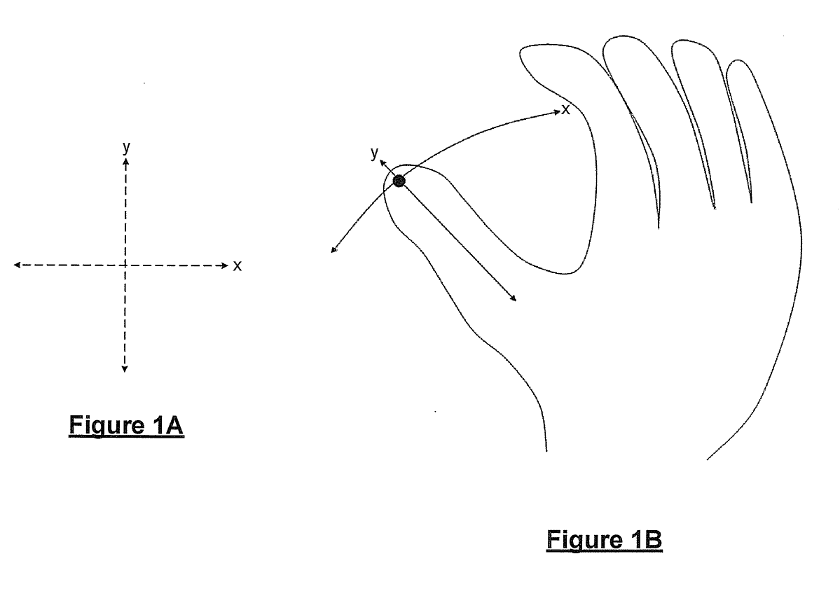

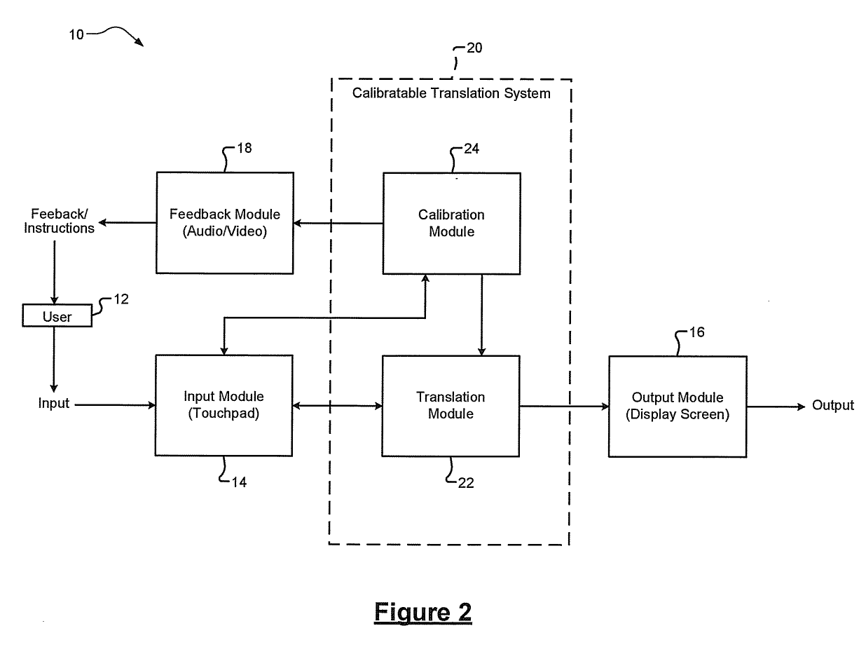

Referring now to FIGS. 1A-1B, standard coordinates (i.e. standard Cartesian coordinates) and a natural non-linear movement of a thumb finger are shown. While a thumb finger (i.e. the carpometacarpal joint) is shown, it can be appreciated that the present disclosure may apply to a hand (i.e. a wrist joint), a lower arm (i.e. the elbow joint), an entire arm (i.e. the shoulder joint), etc. As shown in FIG. 1B, the thumb finger moves along a non-linear x-axis. In other words, the thumb finger x-axis is a curved axis (e.g. a spline). The non-linear movement of the thumb in FIG. 1B corresponds to the easiest physical movement paths of the thumb, and thus mentally corresponds to “normal” x-axis and y-axis movement to the user. Additionally, it can be appreciated that the thumb finger may also move along a non-linear (i.e. curved) y-axis as well.

Referring now to FIG. 2, a system 10 includes a calibratable translation system 20 according to the present disclosure. The system further includes an input module 14 (e.g. a touchpad), an output module 16 (e.g. a display screen), and a feedback module 18 (e.g. an audio/video, or A/V device). In one embodiment, the feedback module 18 may be incorporated into the input module 14 and/or the output module 16. In other words, the input module 14 and/or the output module 16 may provide A/V feedback. The calibratable translation system 20 further includes a translation module 22 and a calibration module 24.

A user 12 provides position input to the input module 14. For example, the position input may be via a finger or a hand and may be controlled by a joint corresponding to a finger, a wrist, an elbow, or a shoulder. The position input may be described as a series of points or positions that collectively make up input movement. Thus, a translation of each input point may be performed and then output (i.e. one position processed per cycle).

The input module 14 communicates with both the translation module 22 and the calibration module 24. In one embodiment, the user 12 may select one of an “translation mode” and a “calibration mode” via the input module 14, and the input module 14 may then enable one of the translation module 22 and the calibration module 24, respectively.

The translation module 22 receives the position input from the input module 14 and translates the input position to an output position for the output module 16 (i.e. translation mode). The translation module 22 may translate the input position to the output position based on one of a plurality of translation methods using predefined (i.e. default) parameters. Alternatively, the translation module 22 may translate the input position to the output position based on one of the plurality of translation methods using calibrated (i.e. modified) parameters. For example, the parameters may include points corresponding to a maximum range of movement or a size of an appendage of the user. In general, a relationship between an input coordinate (x,y) and an output coordinate (x′,y′) may be described as follows:

(x′,y′)=T(x,y),

where T represents one of the plurality of translation methods (i.e. a function, an algorithm, etc.).

In a first exemplary translation method, the translation module 22 generates a coordinate mesh based one of predefined (i.e. default) parameters and calibrated (i.e. modified) parameters. For example, the coordinate mesh may define an area where input movement by the user is expected, and thus the coordinate mesh may be referred to as a sub-area of the input area of the input device. The coordinate mesh further includes a plurality of cells, and thus one of the plurality of cells includes the input position (i.e the input cell). In one embodiment, the coordinate mesh is defined by one or more non-linear curves (e.g. a spline).

Next, the translation module 22 divides the coordinate mesh into a plurality of cells. In one embodiment, the translation module 22 determines vertices of the cells by offsetting the boundaries (i.e. edges) of the coordinate mesh. For example, the translation module 22 may offset an upper boundary of the coordinate mesh multiple times based on a predefined offset distance to create horizontal grid lines of the coordinate mesh. Additionally, for example, the translation module 22 may offset a left boundary of the coordinate mesh multiple times based on a predefined offset distance to create vertical grid lines of the coordinate mesh. Thus, the horizontal and vertical grid lines may define the plurality of cells.

The translation module 22 may then map the plurality of cells of the coordinate mesh to a corresponding plurality of cells of the output module 16. In one embodiment, the output module 16 may be a rectangular display, and the plurality of cells may be rectangular sub-sets of the rectangular display.

Thus, the translation module 22 may determine which cell of the output module 16 corresponds to the cell of the coordinate mesh that includes the position input. Lastly, the translation module 22 determines distances from edges of the cell of the output module 16, and then determines the position output (within the cell) of the output module 16 based on the distances.

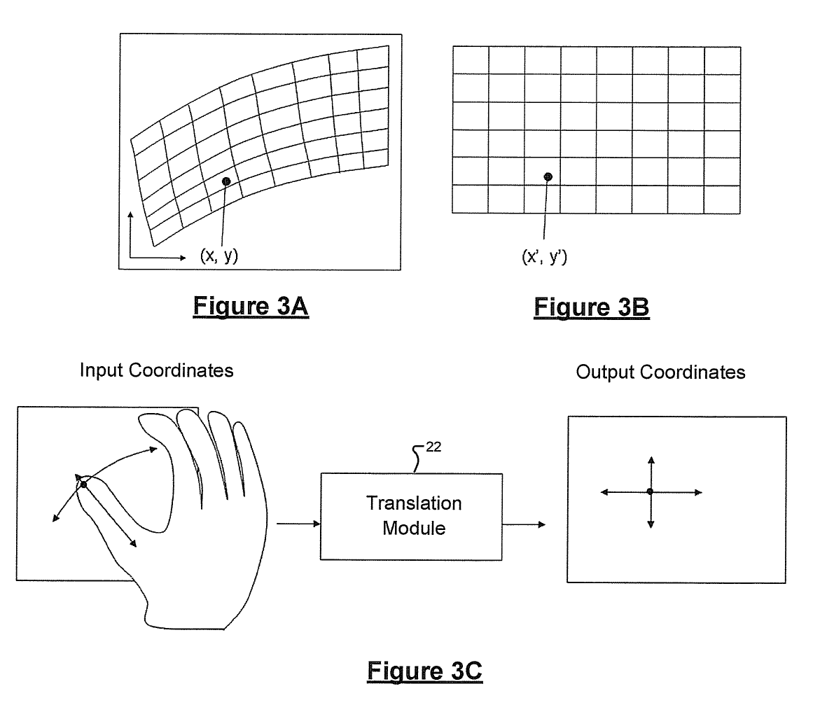

Referring now to FIGS. 3A-3C, graphical representations of the first translation method are shown. FIG. 3A illustrates the coordinate mesh generated by the translation module 22 according to the first translation method. FIG. 3B illustrates the plurality of cells of the output module 16 (i.e. standard Cartesian coordinates). FIG. 3C illustrates the translation of position input in the coordinate mesh by the translation module 22 to the output module 16 according to the first translation method.

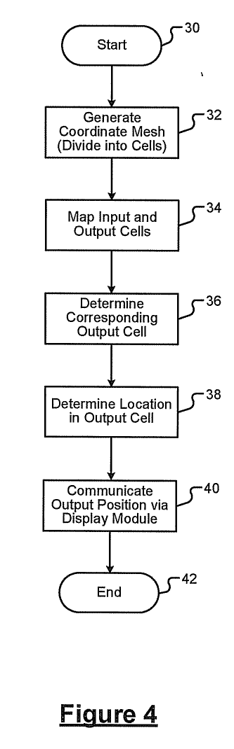

Referring now to FIG. 4, a flow chart of the first translation method begins in step 30. In step 32, the translation module 22 generates the coordinate mesh. For example, the mesh may be a quad mesh. In other words, each cell of the mesh may include four vertices. Alternatively, it can be appreciated that other mesh types may be implemented, such as a triangular mesh (i.e. three vertices per cell). In one embodiment, the coordinate mesh may be generated by determining boundaries of position input and offsetting one or more boundaries multiple times based on a predefined offset distance.

The quad mesh vertices may be described in more detail as follows:
V^{i,j}
V^{i+1,j}
V^{i,j+1},
V^{i+1,j+1}
   where i, j correspond to indices of cells in the quad mesh.

In other words, for each vertex V^{i,j} an input position may be described as (V^{i,j}x, V^{i,j}y) and an output position may be described as (V^{i,j}x′, V^{i,j}y′). Therefore, when the quad mesh is rectangular, calculation of the output position (x′,y′) is relatively simple. However, when the quad mesh is irregular (i.e. one or more curved sides), calculation of the output position (x′,y′) becomes more difficult.

In step 34, the translation module 22 maps cells of the output module 16 to cells of the coordinate mesh. In step 36, the translation module 22 determines which cell of the output module 16 corresponds to the position input. More specifically, the translation module 22 searches the coordinate mesh for a cell that includes the position input (x,y). Thus, vertices for this cell may be described as V^{i,j}, V^{i+1,j}, V_{i,j+1}, and V^{i+1,j+1}.

In step 38, the translation module 22 determines a location within a cell of the output module 16 that corresponds to the position input (x,y). More specifically, the translation module 22 determines distances w₁, w₂, w₃, and w₄ from edges of the cell of the output module 16 and then determines the position output (x′,y′) based on the distances. For example, the position output (x′,y′) may be determined based on the following interpolation:

$${x}^{′} = \frac{{w}_{1} \cdot {V}_{x}^{i , j} + {w}_{2} \cdot {V}_{x}^{i + 1 , j} + {w}_{3} \cdot {V}_{x}^{i , j + 1} + {w}_{4} \cdot {V}_{x}^{i + 1 , j + 1}}{{w}_{1} + {w}_{2} + {w}_{3} + {w}_{4}} , \\ and$$

$${y}^{′} = \frac{{w}_{1} \cdot {V}_{y}^{i , j} + {w}_{2} \cdot {V}_{y}^{i + 1 , j} + {w}_{3} \cdot {V}_{y}^{i , j + 1} + {w}_{4} \cdot {V}_{y}^{i + 1 , j + 1}}{{w}_{1} + {w}_{2} + {w}_{3} + {w}_{4}} .$$

Alternatively, different interpolations may be implemented. For example, a bilinear interpolation or a spline interpolation may be used.

In step 40, the translation module 22 communicates the position output to the output module 16. Control may then end in step 42.

Referring again to FIG. 2, in a second exemplary translation method, the translation module 22 generates a polar coordinate system. Next, the translation module 22 converts the position input (x,y) to polar coordinates (r,θ). Lastly, the translation module 22 interpolates the polar coordinates to determine the position output (x′,y′).

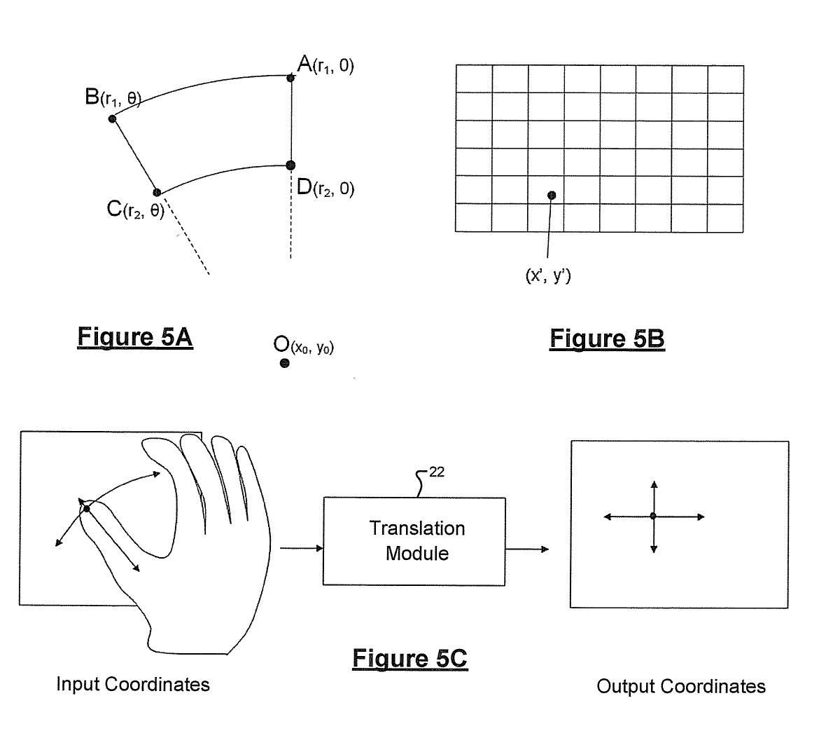

Referring now to FIGS. 5A-5C, graphical representations of the second translation method are shown. FIG. 5A illustrates the generation of the polar coordinate system by the translation module 22 according to the second translation method. FIG. 5B illustrates the cells of the output module 16 (i.e. standard Cartesian coordinates). FIG. 5C illustrates the translation of position input in the coordinate mesh generated by the translation module 22 to the output position of the output module 16 according to the second translation method.

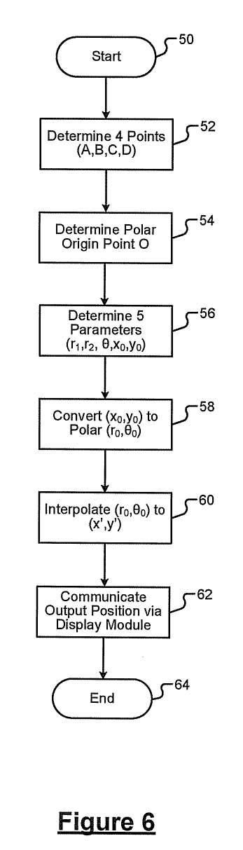

Referring now to FIG. 6, a flow chart of the second translation method begins in step 50. In step 52, the translation module 22 determines four corner points (A, B, C, D) based on the predefined parameters or calibrated parameters. In other words, the four corner points may be included in the predefined (i.e. default) parameters. Alternatively, the four corner points may be input via the calibration module 24 during a calibration process.

In one embodiment, Point B (i.e. the upper left point) corresponds to point (0,0). Additionally, point A corresponds to point (W,0), point C corresponds to point (0,H), and point D corresponds to point (W,H), where W and H are variables corresponding to maximum width and maximum height of input movement.

In step 54, the translation module 22 determines a polar origin point O based on the four corner points A, B, C, and D. For example, the polar origin point O may be determined by determining an intersection point of lines connecting corner points A and D and corner points B and C.

In step 56, the translation module 22 determines five parameters (r₁, r₂, θ, x₀, y₀) based on the four corner points (A, B, C, D). Radius r₁ may be derived from points A and B because points A and B have the same radial distance from origin point O. Similarly, radius r₂ may be derived from points C and D because points C and D have the same radial distance from origin point O. Additionally, angle θ may be derived based on original point O, one of points A and D, and one of points B and C. In one embodiment, the five parameters are generated by the calibration module 24 during a calibration process.

In step 58, the translation module 22 converts the position input (x₀,y₀) to a polar coordinate (r₀,θ₀). More specifically, the position input (x₀,y₀) is translated to a polar coordinate (r₀,θ₀) relative to origin point O.

In step 60, the translation module 22 interpolates the polar coordinates (r₀,θ₀) to determine the position output (x′,y′). More specifically, the polar coordinate (r₀,θ₀) may be interpolated as follows:

$${x}^{′} = ( \frac{θ - {θ}_{0}}{θ} ) \times W , \\ and$$

$${y}^{′} = ( 1 - \frac{{r}_{0} - {r}_{2}}{{r}_{1} - {r}_{2}} ) \cdot H .$$

In step 62, the translation module 22 communicates the position output to the output module 16. Control may then end in step 62.

Referring again to FIG. 2, alternatively, the translation module 22 may translate the position input to the position output based on one of the plurality of translation methods using calibrated (i.e modified) parameters. In other words, the calibration module 24 receives position input from the input module 14 and generates the calibrated parameters based on the position input. More specifically, the calibration module 24 sends feedback (e.g. A/V instructions) to the user 12 via the feedback module 18 according to one of a plurality of calibration methods.

In a first exemplary calibration method, the user 12 is commanded to move the position input to particular points (e.g. lower left) and/or along particular trajectories (e.g. a curved swipe from the upper right to the upper left). Based on the commanded positions and/or commanded trajectories, the calibration module 24 generates calibrated parameters based on movement limits and movement tendencies of the user 12. In one embodiment, the first calibration method applies to the first translation method.

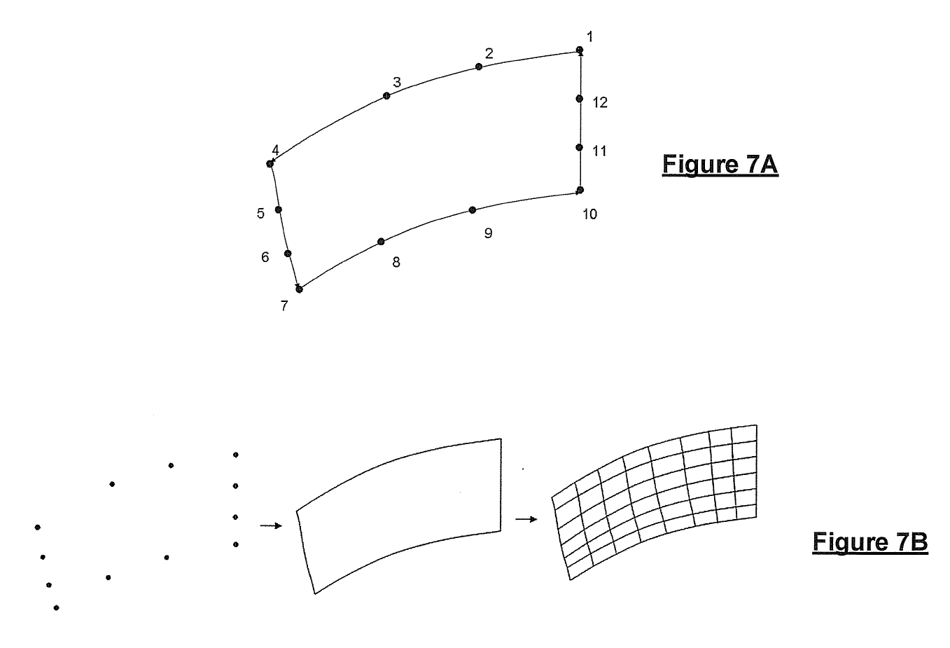

Referring now to FIG. 7A-7B, graphical representations of the first calibration method are shown. FIG. 7A illustrates the sampling of twelve different points for use in generating the coordinate mesh of the first translation method. FIG. 7B illustrates generation and dividing (i.e. offsetting of boundaries) of the coordinate mesh according to the first translation method using calibrated parameters obtained via the first calibration method.

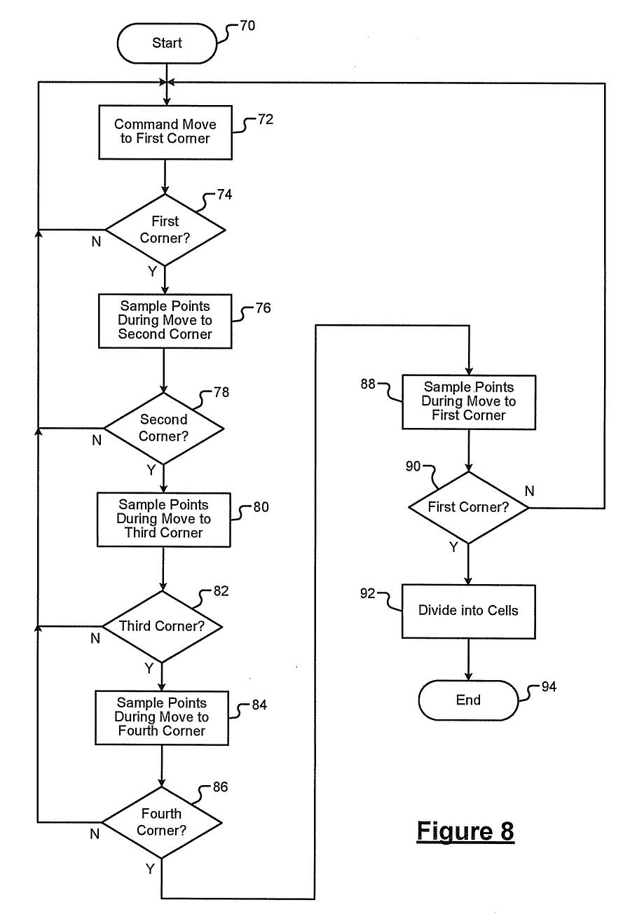

Referring now to FIG. 8, a flow chart of the first calibration method begins in step 70. In step 72, the calibration module 24 commands the user 12 via the feedback module 18 to move the position input to a first corner. For example, the first corner may be an upper right corner.

In step 74, the calibration module 24 determines whether the user 12 has moved the position input to the first corner. If yes, control may proceed to step 76. If no, the calibration module 24 may wait for the user 12 to complete the commanded instruction or control may return control to step 72.

In step 76, the calibration module 24 commands the user 12 via the feedback module 18 to move the position input from the first corner to a second corner. For example, the second corner may be an upper left corner, and the movement may be a curved horizontal swipe in between the two corners. During the movement from the first corner to the second corner, the calibration module 24 may collect sample points based on a predefined sampling rate.

In step 78, the calibration module 24 determines whether the user 12 has moved the position input to the second corner. If yes, control may proceed to step 80. If no, the calibration module 24 may wait for the user 12 to complete the commanded instruction or control may return to step 72.

In step 80, the calibration module 24 commands the user 12 via the feedback module 18 to move the position input from the second corner to a third corner. For example, the third corner may be a lower left corner, and the movement may be a vertical swipe between the two corners. During the movement from the second corner to the third corner, the calibration module 24 may collect sample points based on the predefined sampling rate.

In step 82, the calibration module 24 determines whether the user 12 has moved the position input to the third corner. If yes, control may proceed to step 84. If no, the calibration module 24 may wait for the user 12 to complete the commanded instruction or control may return to step 72.

In step 84, the calibration module 24 commands the user 12 via the feedback module 18 to move the position input from the third corner to a fourth corner. For example, the fourth corner may be a lower right corner, and the movement may be a curved horizontal swipe in between the two corners. During the movement from the third corner to the fourth corner, the calibration module 24 may collect sample points based on the predefined sampling rate.

In step 86, the calibration module 24 determines whether the user 12 has moved the position input to the fourth corner. If yes, control may proceed to step 88. If no, the calibration module 24 may wait for the user 12 to complete the commanded instruction or control may return to step 72.

In step 88, the calibration module 24 commands the user 12 via the feedback module 18 to move the position input from the fourth corner back to the first corner. For example, the movement may be a vertical swipe between the two corners. During the movement from the fourth corner to the first corner, the calibration module 24 may collect sample points based on the predefined sampling rate.

In step 90, the calibration module 24 determines whether the user 12 has moved the position input to the first corner. If yes, control may proceed to step 92. If no, the calibration module 24 may wait for the user 12 to complete the commanded instruction or control may return to step 72. In step 92, the calibration module 24 may divide the a boundary area into the plurality of cells (i.e. quad mesh). For example, the calibration module 24 may offset one or more of the boundaries multiple times based on a predefined offset distance. Control mat then end in step 94 (i.e. calibration process complete).

Additionally, in one embodiment, the calibration module 24 may abandon a current calibration operation when a predetermined period of time expires while waiting for the user 12 to move to a commanded point. Thus, the calibration module 24 may restart the calibration operation by commanding the user 12 to move to the first corner (i.e. step 72). Furthermore, in one embodiment, the predefined sampling rate may be adjustable.

Referring again to FIG. 2, in a second exemplary calibration method, the user 12 is commanded to move the position input to particular points (e.g. lower left). Based on the commanded positions, the calibration module 24 generates calibrated parameters based on movement limits of the user 12. In one embodiment, the second calibration method applies to the second translation method.

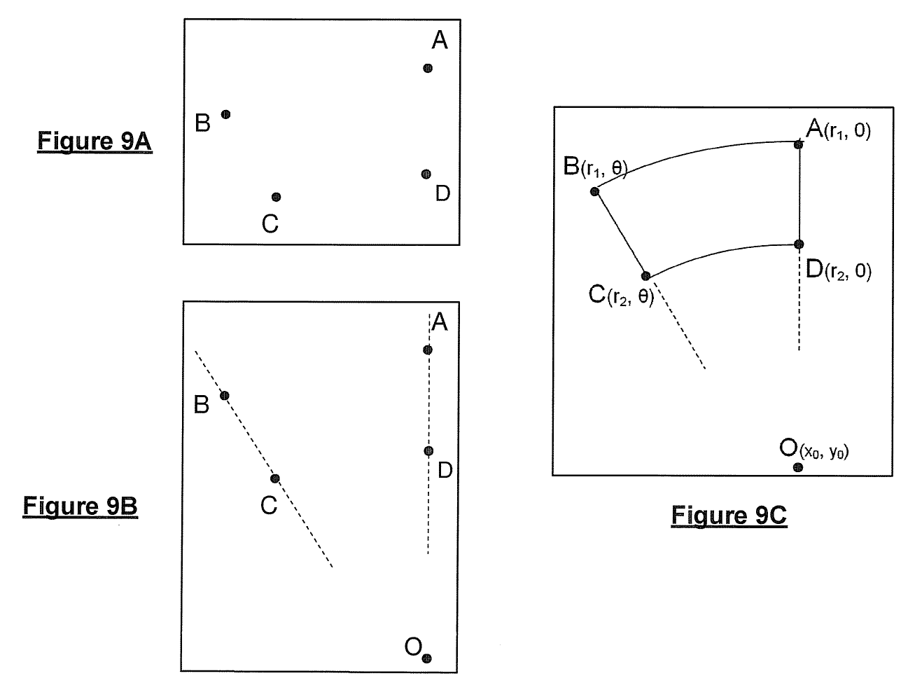

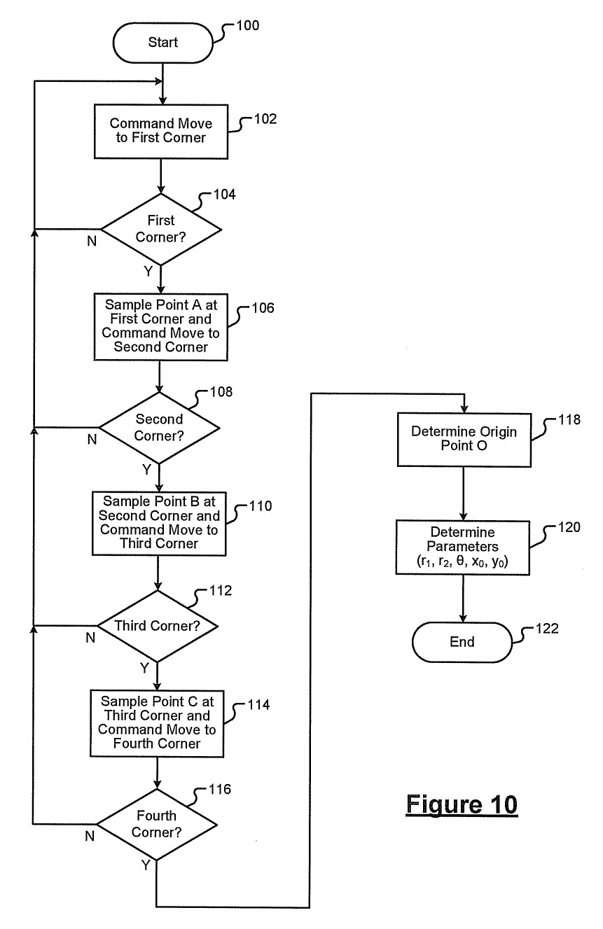

Referring now to FIG. 9A-9C, graphical representations of the second calibration method are shown. FIG. 9A illustrates sampling four points for use in generating the polar coordinate system. FIG. 9B illustrates determining origin point O based on sample points A, B, C, and D. FIG. 9C illustrates generation of the polar coordinate system according to the second translation method using calibrated parameters obtained via the second calibration method.

Referring now to FIG. 10, a flow chart of the second calibration method begins in step 100. In step 102, the calibration module 24 commands the user 12 via the feedback module 18 to move the position input to a first corner. For example, the first corner may be an upper right corner.

In step 104, the calibration module 24 determines whether the user 12 has moved the position input to the first corner. If yes, control may proceed to step 106. If no, the calibration module 24 may wait for the user 12 to complete the commanded instruction or control may return control to step 102. In step 106, the calibration module 24 samples the position input (position A) corresponding to the first corner and commands the user 12 via the feedback module 18 to move the position input from the first corner to a second corner. For example, the second corner may be an upper left corner.

In step 108, the calibration module 24 determines whether the user 12 has moved the position input to the second corner. If yes, control may proceed to step 110. If no, the calibration module 24 may wait for the user 12 to complete the commanded instruction or control may return to step 102. In step 110, the calibration module 24 samples the position input (position B) corresponding to the second corner and commands the user 12 via the feedback module 18 to move the position input from the second corner to a third corner. For example, the third corner may be a lower left corner.

In step 112, the calibration module 24 determines whether the user 12 has moved the position input to the third corner. If yes, control may proceed to step 114. If no, the calibration module 24 may wait for the user 12 to complete the commanded instruction or control may return to step 102. In step 114, the calibration module 24 samples the position input (position C) corresponding to the third corner and commands the user 12 via the feedback module 18 to move the position input from the third corner to a fourth corner. For example, the fourth corner may be a lower right corner.

In step 116, the calibration module 24 determines whether the user has moved the position input to the fourth corner. If yes, control may proceed to step 118. If no, the calibration module 24 may wait for the user 12 to complete the commanded instruction or control may return to step 102.

In step 118, the calibration module 24 determines origin point O based on sampled points A, B, and C. In step 120, the calibration module 24 generates calibrated parameters r₁, r₂, θ, x₀, and y₀. Control may then end in step 122.

Additionally, in one embodiment, the calibration module 24 may abandon a current calibration operation when a predetermined period of time expires while waiting for the user 12 to move to a commanded point. Thus, the calibration module 24 may restart the calibration operation by commanding the user 12 to move to the first corner (i.e. step 102).

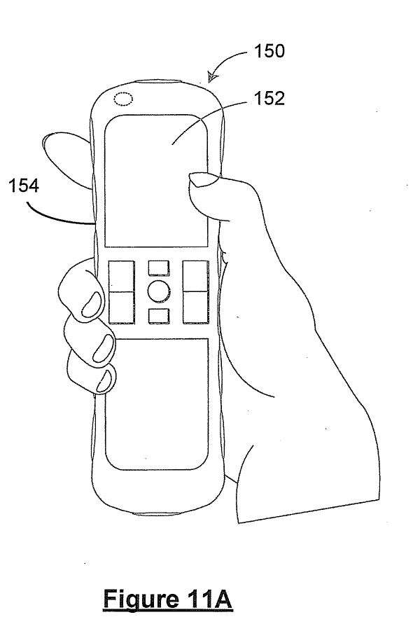

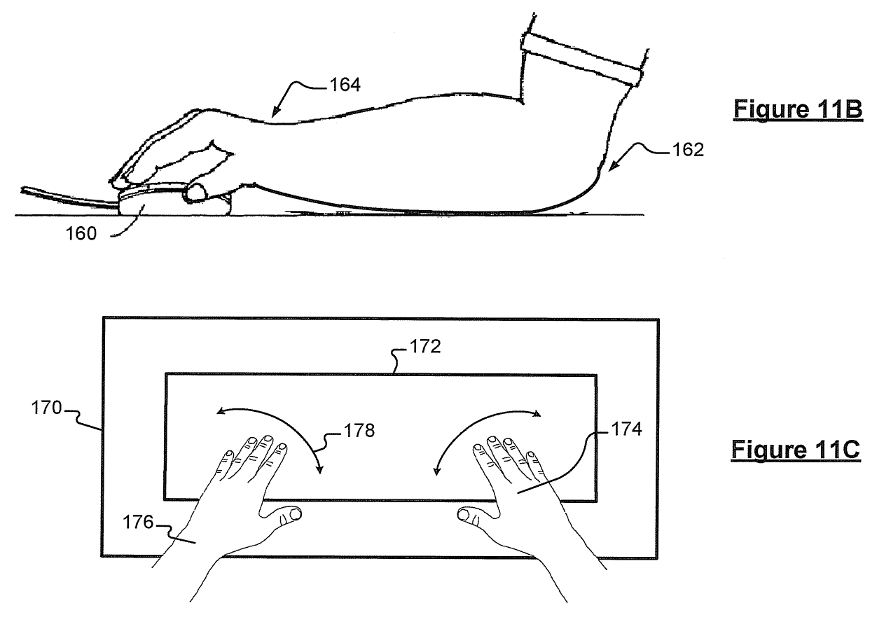

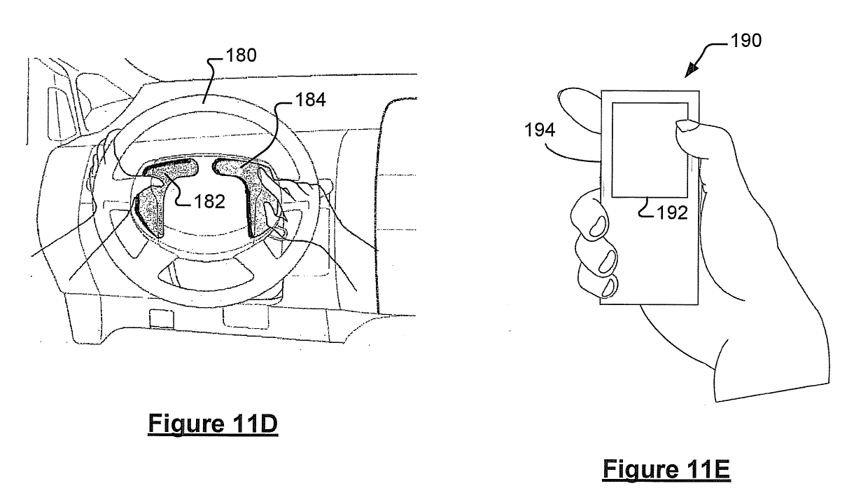

now to FIGS. 11A-11E, exemplary embodiments of the calibratable translation system 20 according to the present disclosure are shown.

Referring now to FIG. 11A, a remote controller 150 that includes the calibratable translation system 20 of the present disclosure is shown. In one embodiment, the remote controller 150 may include at least one touchpad together with an array of additional sensors, such as acceleration sensors, pressure sensors, RF signal sensors, etc. For example, the remote controller may include touchpad 152 for use with a thumb finger and an additional one or more touchpads 154 (located on the opposing side from touchpad 152) for use with other fingers. The touchpads 152, 154 may translate input from the thumb finger and/or other fingers to a display (e.g. a television screen) according to one of the first and second translation methods. Additionally, the remote controller 150 may be calibrated for a particular user according to the first and second calibration methods.

Referring now to FIG. 11B, a computer mouse 160 that includes the calibratable translation system 20 of the present disclosure is shown. For example, the computer mouse 160 may translate non-linear movement from an arm of a user to a computer screen. More specifically, the user may move the computer mouse 160 along non-linear paths due to limitations of an elbow joint 162 and/or a wrist joint 164.

Referring now to FIG. 11C, a large input device 170 that includes the calibratable translation system 20 of the present disclosure is shown. For example, the large input device 170 may be a table that includes a large touchpad 172 that receives position input from one or more hands 174 of a user. Similar to the computer mouse 160 of FIG. 11B, the hand 174 of the user naturally moves around an elbow joint and/or a wrist joint 176 along a non-linear path 178, making it difficult to make straight horizontal and vertical movements.

Referring now to FIG. 11D, a vehicle steering wheel 180 may include one or more input devices 182, 184 that include the calibratable translation system 20 of the present disclosure is shown. For example, the input devices 182, 184 in the steering wheel 180 may be touchpads. Thus, similar to the remote controller 150 of FIG. 11A, a thumb of a user (as seen in input device 182) and/or another finger of the user (as seen in input device 184) naturally move along non-linear paths, making it difficult to make straight horizontal and vertical movements.

Referring now to FIG. 11E, a media player device 190 that includes the calibratable translation system 20 of the present disclosure is shown. For example, the media player device 190 may include a touchpad 192 that receives input from a thumb and/or fingers of a user. Additionally, the media player device 190 may include additional touchpads 194 on the reverse side of the media player device 190 as touchpad 192. Therefore, when a user holds the media player device 190 as shown, the user may input non-linear movement via a thumb on touchpad 192 and/or may input non-linear movement via a different things (e.g. an index finger) on touchpads 194. Similar to the remote controller 150 of FIG. 11, the thumb and/or the fingers may be difficult to move in straight horizontal and vertical directions due to their natural non-linear movement around joints.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A method for translating a position input by a user to a first device to a position output of a second device, comprising:
defining an area of the first device in which input by the user is expected, where the area is less than a total area of the first device, and where the area has a boundary with at least one non-linear side;
receiving position input in the defined area of the first device; and
translating the position input by the user to the first device to the position output of the second device based on a translation method.

2. The method of claim 1, wherein defining the area of the first device in which input by the user is expected is based on predefined default parameters.

3. The method of claim 1, wherein the translation method further includes:
generating a coordinate mesh within the defined area of the first device in which input by the user is expected, wherein the coordinate mesh is divided into a first plurality of cells;
determining one of the first plurality of cells that includes the position input by the user to the first device;
determining one of a second plurality of cells that corresponds to the one of the first plurality of cells, wherein the second device is divided into the second plurality of cells; and
generating the position output of the second device based on distances from edges of the one of the second plurality of cells.

4. The method of claim 1, wherein the translation method further includes:
determining a plurality of vertices of the defined area of the first device in which input by the user is expected;
generating a polar origin point based on the plurality of vertices;
determining polar coordinate parameters based on the origin point and the plurality of vertices;
translating the position input by the user to the first device to a polar coordinate position based on the polar coordinate parameters; and
generating the position output of the second device by interpolating the polar coordinate position.

5. The method of claim 4, wherein the polar coordinate parameters include a first radius, a second radius, and an angle, wherein the first radius and the second radius correspond to distances from arcs each connecting two of the plurality of vertices to the polar origin point, wherein the first radius is greater than the second radius, and wherein the angle is based on an angular difference between two of the plurality of vertices.

6. The method of claim 1, wherein defining the area of the first device in which input by the user is expected is based on parameters generated during a calibration method.

7. The method of claim 6, wherein the calibration method further includes:
commanding the user to input a plurality of positions to the first device;
recording position input both at the plurality of commanded positions and during transitions between the plurality of commanded positions based on a predefined sampling rate; and
defining the area of the first device in which input by the user is expected based on the recorded position input.

8. The method of claim 6, wherein the calibration method further includes:
commanding the user to input a plurality of positions to the first device;
recording position input at the plurality of commanded positions;
determining an origin point based on the recorded position input; and
defining the area of the first device in which input by the user is expected based on the origin point and the plurality of recorded positions.

9. A method for translating a position input from an appendage of a user on a touchpad to a position on a display having a rectangular shape, comprising:
defining an area on the touchpad in which input movement by the appendage of the user is expected based upon the natural movement of joints associated with the appendage;
receiving the position input in the area on the touchpad; and
translating the position input in the area on the touchpad to the position on the display using a translation method.

10. The method of claim 9, wherein defining the area on the touchpad in which input movement by the appendage of the user is expected is based on predefined default parameters.

11. The method of claim 9, wherein the translation method further includes:
generating a coordinate mesh within the defined area on the touchpad in which input from the appendage of the user is expected, wherein the coordinate mesh is divided into a first plurality of cells;
determining one of the first plurality of cells that includes the position input from the appendage of the user on the touchpad;
determining one of a second plurality of cells that corresponds to the one of the first plurality of cells, wherein the display is divided into the second plurality of cells, and wherein the second plurality of cells are rectangular; and
generating the position on the display based on the position input based on distances from edges of the one of the second plurality of cells.

12. The method of claim 9, wherein the translation method further includes:
determining a plurality of vertices of the defined area on the touchpad in which input from the appendage of the user is expected;
generating a polar origin point based on the plurality of vertices;
determining polar coordinate parameters based on the origin point and the plurality of vertices;
translating the position input in the area on the touchpad to a polar coordinate position based on the polar coordinate parameters; and
generating the position on the display by interpolating the polar coordinate position.

13. The method of claim 12, wherein the polar coordinate parameters include a first radius, a second radius, and an angle, wherein the first radius and the second radius correspond to distances from arcs each connecting two of the plurality of vertices to the polar origin point, wherein the first radius is greater than the second radius, and wherein the angle is based on an angular difference between two of the plurality of vertices.

14. The method of claim 9, wherein defining the area on the touchpad in which input from the appendage of the user is expected is based on parameters generated during a calibration method.

15. The method of claim 14, wherein the calibration method further includes:
commanding the user to move the appendage to a plurality of positions on the touchpad;
recording position input both at the plurality of commanded positions and during transitions between the plurality of commanded positions based on a predefined sampling rate; and
defining the area on the touchpad in which input from the appendage of the user is expected based on the recorded position input.

16. The method of claim 14, wherein the calibration method further includes:
commanding the user to move the appendage to a plurality of positions on the touchpad;
recording position input at the plurality of commanded positions;
determining an origin point based on the recorded position input; and
defining the area on the touchpad in which input from the appendage of the user is expected based on the origin point and the plurality of recorded positions.

17. A calibratable system for translating a position input by a user to a first device to a position output of a second device, comprising:
a translation module that receives the position input by the user to the first device and that translates the position input to position output for the second device based on a plurality of parameters and a translation method; and
a calibration module that selectively generates the plurality of parameters based on a calibration method that commands the user to move the position input to locations defined by the calibration method.

18. The system of claim 17, further comprising:
the first device that receives the position input from the user and sends the position input to at least one of the translation module and the calibration module.

19. The system of claim 18, wherein the first device enables one of the calibration module and the translation module based on a mode of operation selected by the user.

20. The system of claim 19, wherein the first device is a touchpad.

21. The system of claim 17, further comprising:
the second device that receives the position output from the translation module and displays the position output.

22. The system of claim 21, wherein the second device is a display screen.

23. The system of claim 17, further comprising:
a feedback module that receives the commands from the calibration module and generates at least one of audio and visual signals for the user.

24. The system of claim 23, wherein the at least one of audio and visual signals generated by the feedback module are communicated to the user via at least one of the first device and the second device.

25. The system of claim 23, wherein the at least one of audio and visual signals generated by the feedback module are communicated to the user via at least one of an audio device and a visual device, respectively.

26. The system of claim 25, wherein the audio device is a speaker and the visual device is a display screen.

27. The system of claim 17, wherein the translation method is the translation method of claim 1.

28. The system of claim 17, wherein the translation method is one of the translation methods of claims 3 and 4.

29. The system of claim 17, wherein the translation method is the translation method of claim 9.

30. The system of claim 17, wherein the translation method is one of the translation methods of claims 11 and 12.

31. The system of claim 17, wherein the calibration method is one of the calibration methods of claims 6 and 7.

32. The system of claim 17, wherein the calibration method is one of the calibration methods of claims 15 and 16.
